(19) United States
(12) Patent Application Publication
(10) Pub. No.: US 2026/0118542 A1
(43) Pub. Date: Apr. 30, 2026

(54) SYSTEMS AND METHODS FOR ESTIMATING COHERENCY OF ACTIVE AND PASSIVE SEISMIC SIGNALS

(71) Applicant: Schlumberger Technology Corporation, Sugar Land, TX (US)

(72) Inventors: Weiping Cao, Sugar Land, TX (US); Takashi Mizuno, Sugar Land, TX (US)

(21) Appl. No.: 18/930,742

(22) Filed: Oct. 29, 2024

(51) Int. Cl. G01V 1/50

(52) U.S. Cl. CPC G01V 1/50

(57) ABSTRACT

A method may include receiving a plurality of seismic traces, from a plurality of seismic recorders associated with a geologic area of interest. The method may also involve modifying the plurality of seismic traces to obtain a consistent polarity for each seismic trace of the plurality of seismic traces. The method may then include generating a single waveform based on the plurality of modified seismic traces, and determining coherent energy values for the seismic events in the plurality of seismic traces based on the plurality of seismic traces and the single waveform.

### BACKGROUND

The present disclosure relates generally to seismic signal processing. More particularly, the present disclosure relates to a method of correcting polarity reversals in seismic trace gathers such that the semblance of the event may be determined.

Seismic surveys may be conducted for a number of geology related activities, including hydrocarbon recovery. As hydrocarbons are extracted from hydrocarbon reservoirs via hydrocarbon wells in oil and/or gas fields, a number of sensors may be deployed at the wellsite to determine information relating to subsurface formations. Further, sensors may be used to detect seismic events and the sources of events.

Seismic events may be detected using seismic data by a number of methods, including determining the semblance of the event. Semblance generally relates to the coherency of signals of an event. Methods for calculating seismic semblance include stacking seismic traces recorded for a seismic event and normalizing the stacked waveform with the combined energy of the stacked traces. With the foregoing in mind, improved methods for determining the semblance of a seismic event may be useful in seismic data analysis

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a method may include receiving a plurality of seismic traces, from a plurality of seismic recorders associated with a geologic area of interest. The method may also involve modifying the plurality of seismic traces to obtain a consistent polarity for each seismic trace of the plurality of seismic traces. The method may then include generating a single waveform based on the plurality of modified seismic traces, and determining a coherent energy value associated with the plurality of seismic traces based on the plurality of seismic traces and the single waveform.

Various refinements of the features noted above may be made in relation to various aspects of the present disclosure. Further features may also be incorporated in these various aspects as well. These refinements and additional features may be made individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various features, aspects, and advantages of the present disclosure will become better understood when the following detailed description is read with reference to the accompanying figures in which like characters represent like parts throughout the figures, wherein:

FIG. 1 illustrates a schematic diagram of a water seismic survey and a land seismic survey recording multiple seismic measurements, according to an embodiment of the present disclosure;

FIG. 2 illustrates a wellsite and seismic sensing system, according to an embodiment of the disclosure;

FIG. 3 illustrates a block diagram of a computing system that may perform certain operations according to an embodiment of the disclosure;

FIG. 4 illustrates a flowchart of a method of processing seismic traces, in accordance with an embodiment of the disclosure; and

FIG. 5 illustrates an example of a visual representation of a seismic trace processing method, in accordance with an embodiment of the disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The drawing figures are not necessarily to scale. Certain features of the embodiments may be shown exaggerated in scale or in somewhat schematic form, and some details of conventional elements may not be shown in the interest of clarity and conciseness. Although one or more embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

When introducing elements of various embodiments of the present disclosure, the articles “a,” “an,” and “the” are intended to mean that there are one or more of the elements. The terms “including” and “having” are used in an open-ended fashion, and thus should be interpreted to mean “including, but not limited to . . . ” Any use of any form of the terms “couple,” or any other term describing an interaction between elements is intended to mean either an indirect or a direct interaction between the elements described.

Certain terms are used throughout the description and claims to refer to particular features or components. As one skilled in the art will appreciate, different persons may refer to the same feature or component by different names. This document does not intend to distinguish between components or features that differ in name but not function, unless specifically stated.

Seismic activity may be measured to provide data regarding the composition of a subsurface region of the earth to identify hydrocarbon deposits and the like. A number of seismic sources may generate seismic activity, including active sources such as air guns and vibrators, and passive sources such as natural and induced earthquakes. The latter of the two sources, passive sources, can aid in performing hydrocarbon recovery operations by providing information relating to subsurface formations. For example, a hydrocarbon recovery operation may include hydraulic fracturing as a well stimulation method. In hydraulic fracturing operations, seismic activity measurements may provide information regarding the location/timing of source rock fracturing, which may assist in determining information about hydrocarbons that may be recovered from a source rock. In such an example, to detect activity associated with rock fracturing a number of suitable seismic sensors may be used within the vicinity of a wellbore in which the hydraulic fracturing may take place. By way of example, a Distributed Acoustic Sensing (DAS) system may detect seismic activity using a fiber optic cable positioned along a downward length of the wellbore. The DAS system may record and interpret optical signals with an optoelectronic device, such that the fiber optic cable may send a signal indicative of strain at multiple locations along its length. As a result, the optoelectronic device may record the signal as a seismic signal trace. Subsequently, the recorded seismic traces may be processed and used to determine seismic activity at or around the wellbore. While one example of an application using seismic activity sensing has been discussed above, there are multiple applications for which seismic activity sensing may be used.

Seismic signal traces may be processed in a number of ways relating to seismic event detection. In many cases, a number of sensors may be positioned proximate to a wellbore or geologic area of interest, at different radii from an anticipated seismic event location. As a result, when a seismic event occurs, the event may be captured as a number of seismic traces from a number of different positions. After gathering the traces, the traces may be processed for coherence analysis. Processing operations may include noise removal and trace alignment. The traces may then be combined into one constructive waveform referred to herein as “stacking”. In some cases, the signal traces detected from seismic sensors may include noise components. Therefore, event detection may further be determined by determining the semblance of the event or the signal coherency of the event. The semblance of an event may be determined by normalizing the amplitude of the stacked traces with an energy trace associated with the seismic traces. Events with high coherency may thus display high semblance values, while events with low coherency may display low semblance values as compared to the high semblance values.

With this in mind, semblance calculations based on raw seismic traces alone may not be robust enough to determine the occurrence of the seismic events. That is, seismic sensor configurations may not entirely detect seismic events due to waveform polarity changes along the traces caused by the seismic source mechanism or changes in seismic wave propagation direction during an event. For example, a trace detected by one seismic sensor may be a wave of positive polarity, while a trace of the same event detected by a separate seismic sensor may be a wave of negative polarity. As a result, when the aforementioned traces are stacked, the resulting waveform is diminished due to destructive interference. In this manner, it is difficult to accurately estimate the coherency of the event given that the resulting semblance value calculated for an event with destructive interference may be small relative to other seismic events and indicate a lack of event continuity. This issue is exacerbated for microseismic events, where the detected traces are small as compared to traces generated by active sources.

The present disclosure generally relates to a method of accurately measuring the coherency of seismic signals, such that a change in wave propagation direction during a seismic event, resulting in a waveform polarity flip, is accounted for. In certain embodiments, a data analysis system may receive an array of signal traces of a seismic event and process the traces for coherence analysis. The data analysis system may then convert each trace into its complex form (e.g., containing a real portion and an imaginary portion). When in complex form, the data analysis system may double the instantaneous phase, such that the phase difference between any trace in the array is 360 degrees rather than 180 degrees. As the polarity difference for traces within the event is corrected, the data analysis system may stack the traces without destructive interference. Once the traces are stacked, the data analysis system may divide the phase in half to restore the anticipated waveform, e.g. the waveform to be expected if all of the original seismic traces displayed positive polarity. Moreover, the data analysis system may calculate an event semblance by normalizing the phase-halved stacked trace with an energy trace associated with the seismic traces. As a result, the data analysis system may identify the semblance value that accurately represents the coherency of the seismic signal traces recorded for the seismic event, thereby enhancing seismic event detection.

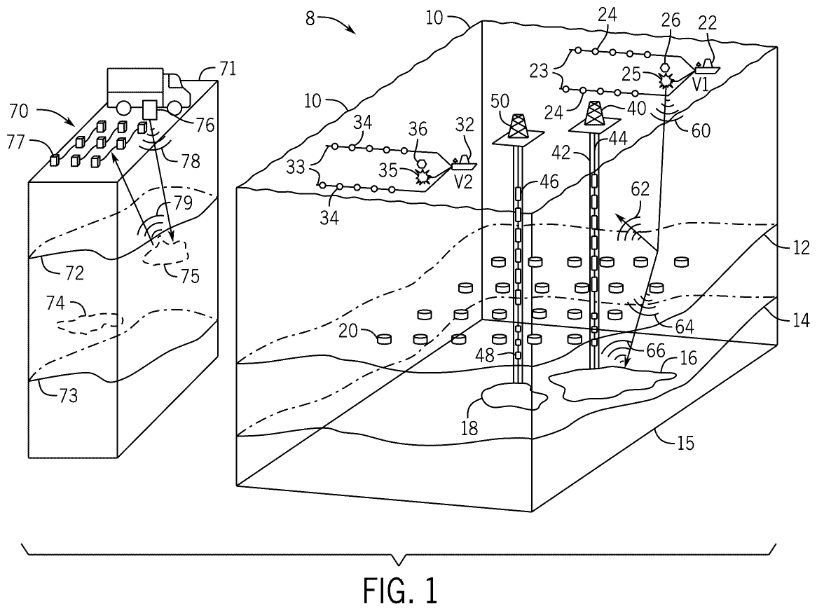

By way of introduction, FIG. 1 illustrates an example schematic diagram of a water seismic survey and a land seismic survey using multiple seismic measurements. A water area 8 may include a surface 10 and a water bottom 12. Water depth in the shallow water area may vary from a few meters to 150 meters. Multiple subsurface layers (e.g., subsurface layers 14 and 15) may be located beneath the water bottom 12. Geological formations, such as subsurface formations 16 and 18 embedded in the subsurface layers, may contain hydrocarbon deposits. Seismic data acquired in the water seismic survey may be used to provide information regarding the water bottom 12, the subsurface layers 14 and 15, and the subsurface formations 16 and 18. Information acquired relating to subterranean geologic structures may provide indications of the hydrocarbon deposits.

The water seismic survey may include ocean bottom node (OBN) measurement by employing multiple OBNs 20 on the water bottom 12. The OBNs 20 may be deployed (e.g., using remotely operated vehicles (ROVs)) to selected locations and form a certain geometry (e.g., an OBN patch with 80 meters by 80 meters grid size). Each of the OBNs 20 may include one or more OBN sensors. The OBN sensors may include one or more geophones (e.g., single-component, two-component, three-component geophones). In some embodiments, the OBN sensors may also include hydrophones.

One or more seismic source vessels may be used in the shallow water seismic survey. For example, a source vessel 22 towing a seismic source 25 and another source vessel 32 towing another seismic source 35 may be used to create seismic waves propagating downward into the subterranean geologic structures. Each of the seismic sources 25 and 35 may include one or more source arrays and each source array may include a certain number of air guns.

The water seismic survey may also include streamer measurement by employing multiple streamers traversing the water. For example, the source vessel 22 may tow multiple (e.g., two, four, six, eight, or ten) streamers 23 along one sail line, and the source vessel 32 may tow multiple streamers 33 along another sail line. The streamer measurement may be acquired simultaneously with the OBN measurement using shots fired by the seismic sources 25 and 35. Each streamer may include multiple streamer sensors. For example, each of the streamers 23 may include streamer sensors 24 and each of the streamers 33 may include streamer sensors 34. The streamer sensors 24 and 34 may include hydrophones that create electrical signals in response to water pressure changes caused by reflected seismic waves that arrive at the hydrophones.

The water seismic survey may also include near field hydrophone (NFH) measurement by employing multiple NFHs close to the seismic sources. For example, an NFH 26 may be deployed in close proximity to the seismic source 25 and another NFH 36 may be deployed in close proximity to the seismic source 35.

The water seismic survey may further include vertical seismic profile (VSP) measurement by employing seismic sensors (e.g., fiber-optic sensors, geophones, or hybrid sensors) in one or more wells. For example, a hybrid sensor array including fiber-optic sensors 46 and geophones 48 may be disposed along a wireline cable 44 deployed in a borehole 42 of a well 40, which may be drilled into the subsurface formation 16. Similar seismic sensors may be deployed in another well 50, which may be drilled into the formation 18. The fiber-optic sensors 46 may measure strains caused by reflected or refracted seismic waves traveling along the hybrid sensor array. The geophone 48 may measure ground motions (e.g., particle movements such as velocity and acceleration) caused by seismic waves traveling along the hybrid sensor array.

During the water seismic survey, the seismic source 25 may be activated to generate seismic waves 60 traveling downward into the subterranean geologic structures. When the seismic waves 60 arrives at the water bottom 12, a portion of seismic energy contained in the seismic waves 60 is reflected by the water bottom 12. Reflected waves 62 travel upward and arrive at different sensors, such as the streamer sensors 24 and 34, the NFHs 26 and 36, and the fiber-optic sensors 46, where they are measured by corresponding sensors. Another portion of the seismic energy contained in transmitted seismic waves 64 propagated through the water bottom 12 into the subsurface layer 14. A portion of seismic energy contained in the transmitted waves 64 is reflected by the subsurface formation 16. Reflected waves 66 travel upward and arrive at the different sensors, where they are measured by the corresponding sensors.

A land area may include a land surface 71, subsurface layers 72 and 73, and subsurface formations 74 and 75 embedded in the subsurface layers 72 and 73 that may contain hydrocarbon deposits. Seismic data acquired in the land seismic survey may be used to image the subsurface layers 72 and 73, and subsurface formations 74 and 75. Images of subterranean geologic structures may provide indications of the hydrocarbon deposits.

The land seismic survey may include a seismic vibrator 76 in direct contact with the land surface 71 (e.g., hydraulically driven vibrating plate) that vibrates to generate seismic waves 78 at certain frequencies, durations, and intensities. The seismic vibrator 76 may be attached to a vehicle that moves along paths on the land surface 71, allowing the seismic vibrator 76 to direct the seismic waves 78 at different directions within a volume of the land seismic survey. The seismic waves 78 generated by the seismic vibrator 76 may propagate downward into the subterranean geologic structures, and a portion of the seismic waves 78 may reflect off of the subterranean geologic structures as reflected waves 79. The reflected waves 79 may travel upwards and arrive at an array or one or more land-based sensors (e.g., geophones) 77, where they are measured by the one or more land-based sensors 77.

It should be noted that the elements described above with regard to the water seismic survey and land seismic survey are exemplary elements. For instance, some embodiments of the water seismic survey and/or the land seismic survey may include additional or fewer elements than those shown. In some embodiments, the water seismic survey may include different number of source vessels. In some embodiments, separated receiver vessels may be used to tow the streamers. In some embodiments, the streamer measurement may be acquired independently from the OBN measurement for operational or logistical reasons.

As previously mentioned, the sensors may be deployed in several configurations to monitor seismic activity in land and water-based environments. There are several applications in which seismic monitoring may provide useful information, including but not limited to, carbon monitoring, geothermal resource detection, and unconventional hydrocarbon resource detection. In particular, a specific application for which seismic monitoring may be used is hydrocarbon recovery operations where well stimulation methods are utilized.

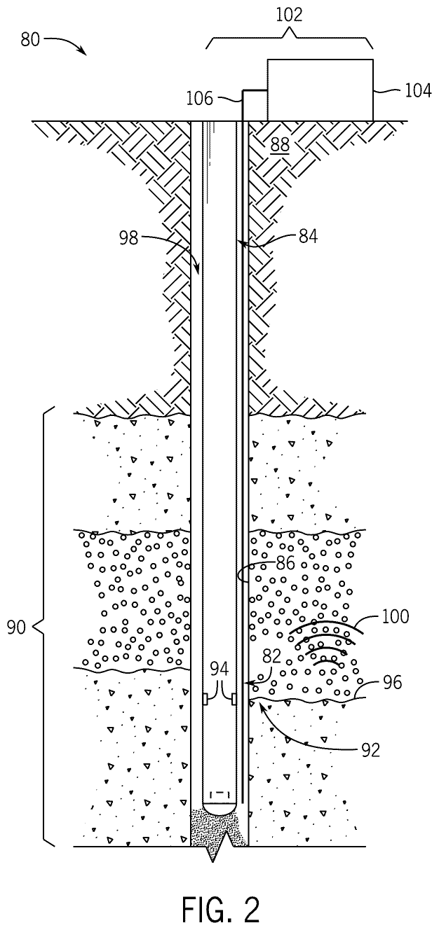

With the foregoing in mind, FIG. 2 illustrates an example of a case in which a Distributed Acoustic Sensing (DAS) system may be disposed within a borehole casing to monitor well stimulation activities. Well stimulation activities may encompass a number of well stimulation methods, including hydraulic fracturing as mentioned below. It should be understood that the example provided in FIG. 2 is provided to facilitate explanation of the systems and techniques described herein. However, it should be noted that a variety of seismic monitoring systems, stimulation systems, and other well or non-well related systems may utilize the methodology described herein. Moreover, the DAS system and hydraulic fracturing system described herein may both comprise a variety of components arranged in various configurations depending on the parameters of a specific perforating/stimulating operation.

Referring now to FIG. 2, a well system 80 may include a well stimulation system and a monitoring system. The well stimulation system may include a jet perforating tool 82 deployed on a tubing string 84. In certain embodiments, the tubing string 84 may be a coiled tubing string having coiled tubing. The tubing string 84 further may include a variety of additional and/or alternate components, depending in part on the specific perforating and stimulating application, the geological characteristics, and the well type. In the illustrated embodiment, the tubing string 84 is deployed in a borehole 98 within a casing 86.

Further, in the illustrated embodiment, the borehole 98 extends down through a subterranean formation 88 having a number of well zones 90 composed of permeable rock. Each of the well zones 90 may be selectively perforated to form a number of perforations 92 which may be stimulated (e.g. fractured) by any appropriate method for hydrocarbon recovery. The perforations 92 may be formed by high-pressure jets of fluid discharged through at least one perforating jet nozzle 94 of the jet perforating tool 82. While the jet perforating tool 82 is shown in the illustrated embodiment as having one jet nozzle 94, it should be noted that the jet perforating tool 82 may include multiple jet nozzles. The jet nozzles 94 direct jets of fluid outward through casing 86 to create perforations in the well zones 90.

After the casing 86 is perforated, fracturing fluids may be pumped into the perforations 92 to induce the creation of one or more hydraulic fractures 96 within the well zone 90. The fracturing fluid may be any suitable type(s) of fluid, but is commonly a mixture of water, thickening agents, and proppants. Through the hydraulic fractures 96, the borehole 98 may enable access to the hydrocarbon reservoir, such that the well system 80 may initiate a hydrocarbon recovery operation.

In some embodiments, a DAS system 102 may include a fiber optic cable 106, communicatively coupled with an optoelectronic device 104. The optoelectronic device may be an optical interrogator, capable of interpreting signals from the fiber optic cable 106. For example, during operation of the DAS system 102, the optoelectronic device 104 may send optical pulses along the length of the fiber optic cable 106, and measure Rayleigh scattering that occurs along the length of the cable. In this manner, when seismic activity such as the seismic waves 100, produce acoustic waves thereby straining the fiber optic cable, backscattering measured by the optoelectronic device 104 may be interpreted as seismic data.

In the illustrated example, the DAS system 102 is positioned vertically downward by disposing the fiber optic cable 106 within the casing 86 of the borehole 98, such that the fiber optic cable 106 does not interfere with the operations of the well system 80. The optoelectronic device 104 may be positioned above ground and connected to the fiber optic cable 106. While a single fiber optic cable 106 is illustrated, it should be understood that a DAS system 102 may consist of multiple fiber optic cables 106 disposed within the casing 86 of a borehole 98 in a well system 80.

As previously mentioned, the DAS system 102 is deployed within the well system 80 to monitor resulting seismic activity from well stimulation methods. In the previously mentioned example of hydraulic fracturing, seismic waves 100 may be produced upon the creation of hydraulic fractures 96 and propagate through the well zones 90 and subterranean formation 88. The DAS system may record strain in the fiber optic cable 106 in response to experiencing acoustic vibrations from the seismic waves 100 via the optoelectronic device 104. As such, seismic traces may be determined by the DAS system 102. However, due to the seismic source mechanism or changes in the direction of the seismic wave 100 propagation, the DAS system 102 may record seismic traces that display inconsistent polarity.

With the foregoing in mind, the DAS system 102 may be communicatively coupled to a data analysis system 108 to record, interpret, and analyze data collected at the wellsite. In this manner, the operations requiring seismic monitoring at the wellsite may be analyzed by the data analysis system 108 to provide information to operators and control various aspects of the operation. In the above example, the data analysis system 108 may analyze the seismic traces produced by seismic waves 100, as recorded by the DAS system 102. Upon analyzing the seismic traces, the data analysis system 108 may display information to operators such as the location/timing of the creation of hydraulic fractures 96. In another example, the data analysis system 108 may control aspects of the well stimulation operation based on seismic trace analysis, such as the flow rate of proppant pumped into the hydraulic fractures 96. As such, the data analysis system 108 may aid in hydrocarbon recovery operations. As previously mentioned, although the previous example discloses a DAS system 102 communicatively coupled with the data analysis system 108, it should be understood that any number of suitable seismic monitoring systems may be coupled with the data analysis system 108 to perform the methods described herein.

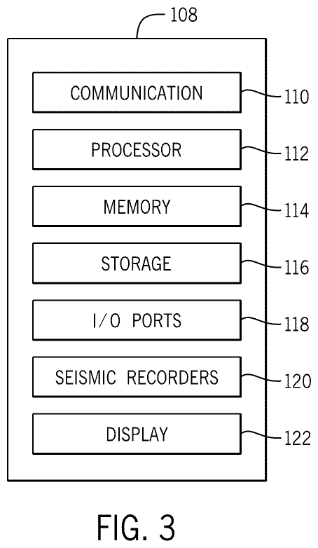

FIG. 3 illustrates a detailed block diagram of components in the data analysis system 108 that may be used to perform the techniques described herein. As previously mentioned, the data analysis system 108 may include a communication component 110, a processor 112, a memory 114, a storage 116, I/O ports 118, seismic recorders 120, display 122, and the like. The communication component 110 may be a wireless or wired communication component that may facilitate communication between the data analysis system 108 and the seismic recorders 120. Further, the communication component 110 may consist of multiple channels configured to transmit data between the seismic recorders 120 and the data analysis system 108. As previously discussed, the seismic recorders 120 may be any suitable seismic sensing device(s) such as geophones, fiber optic cables, ocean bottom nodes, hydrophones, streamers, or a combination thereof.

The processor 112 may be any type of computer processor or microprocessor capable of executing computer-executable code. The processor 112 may also include multiple processors that may perform the operations described below. As such, the processor 112 may execute any suitable type(s) of software packages or code for signal processing and data analysis.

Further, the memory 114 and the storage 116 may be any suitable articles of manufacture that can serve as media to store processor-executable code, data, or the like. These articles of manufacture may represent computer-readable media (i.e., any suitable form of memory or storage) that may store the processor-executable code used by the processor 112 to perform the presently disclosed techniques. The memory 114 and the storage 116 may also be used to store the data, analysis of the data, and the like. The memory 114 and the storage 116 may represent non-transitory computer-readable media (i.e., any suitable form of memory or storage) that may store the processor-executable code used by the processor 112 to perform various techniques described herein. It should be noted that non-transitory merely indicates that the media is tangible and not a signal. The I/O ports 118 may be interfaces that may couple to other I/O devices such as keyboards, mice, or other tools used to interface with the data analysis system 108.

The display 122 may include any type of electronic display such as a liquid crystal display, a light-emitting-diode display, and the like. As such, data acquired via the communication component 110 and/or data analyzed by the processor 112 may be presented on the display 122, such that the resulting processed seismic data may be displayed in a usable manner. In certain embodiments, the display 122 may be a touch screen display or any other type of display capable of receiving inputs from an operator.

Although the data analysis system 108 is described as including the components presented in FIG. 3, the data analysis system 108 should not be limited to including the components listed in FIG. 3. Indeed, the data analysis system 108 may include additional or fewer components than described above.

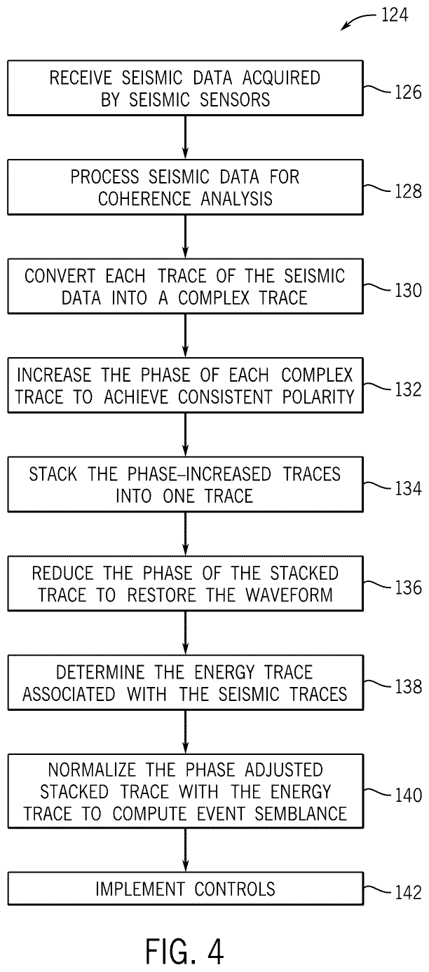

With the foregoing in mind, FIG. 4 illustrates a method 124 for determining the semblance of a seismic event to compensate for inconsistent wave polarities amongst seismic traces of the event. Although the following description of the method 124 is described as being performed by data analysis system 108, in accordance with FIG. 3, it should be noted that the method 124 may be performed in any suitable order and by any suitable computing system.

Referring now to FIG. 4, at block 126, the data analysis system 108 may receive seismic data associated with a seismic event recorded by the seismic recorders 120. The data may be any suitable data to describe wave propagation of a seismic event, such as a seismic trace. As referred to herein, a seismic trace may represent a measured response to disturbances in the elastic wavefield of a geologic medium for a period of time. As such, a seismic trace may be a waveform represented mathematically by descriptive elements such as amplitude, frequency, and phase. In certain embodiments, the seismic data may be a gather of seismic traces, where the gather is a group of a number of channels of the seismic recorders 120 that record data during a seismic event. For the purpose of facilitating the discussion of the techniques disclosed herein, an original seismic trace received at block 126 may be represented by the following variable:

$$w ( {x}_{l} , {t}_{i} )$$

where seismic trace w(xₗ, tᵢ) represents a sample x recorded at channel l for time tᵢ.

At block 128, the data analysis system 108 may implement waveform processing procedures to the recorded seismic gather. These processing procedures may include noise removal steps (e.g., bandpass filtering), trace alignment operations, or a combination thereof. In certain embodiments, a trace alignment operation may include shifting each seismic trace in the gather with time shifts associated with respective seismic recorder locations, such that coherent event arrivals in different traces in the gather display identical arrival times. Although one trace alignment operation is described herein, any trace alignment operation(s) may be applied to align the seismic traces of the seismic trace gather such that the traces display identical event arrival times.

Moving to block 130, the data analysis system 108 may convert each trace of the seismic trace gather into a complex trace (e.g., having a real portion and imaginary portion) by a suitable signal processing algorithm, such that the trace may be manipulated analytically. In certain embodiments, the conversion may be achieved by applying the Hilbert Transform to each seismic trace of the gather. The complex trace determined at block 130 may be represented by the following variable:

$$c ( {x}_{l} , {t}_{i} )$$

where c(xₗ, tᵢ) represents the complex trace determined from seismic trace w(xₗ, tᵢ), which represents the sample recorded at channel l for time tᵢ.

As previously mentioned, by nature of the seismic recorders 120, the collection of seismic traces recorded for a seismic event may not display a consistent polarity. For example, two traces within a seismic trace gather of an event may display a phase difference of 180 degrees by having one trace display positive polarity and one trace display negative polarity. As a result, when the two traces are combined, destructive interference occurs. To avoid this result, the data analysis system 108 may correct the polarity difference by applying a suitable operation to the complex seismic traces obtained from block 130.

As such, at block 132, the data analysis system 108 may increase to the instantaneous phase of each complex trace to achieve consistent polarity. In the previously mentioned example, the phase difference of two traces may be 180 degrees. In response, the data analysis system 108 may determine a suitable factor to correct the phase difference, such that combining traces may not result in destructive interference. As such, upon doubling the instantaneous phase of each trace, the resulting phase difference is 360 degrees. In this manner, upon combining two traces having a phase difference of 360 degrees, the resulting waveform may be constructive rather than destructive. The aforementioned constructive wave is the targeted result of stacking in seismic signal processing. For the purpose of facilitating discussion, the phase-increased seismic trace may be represented by the following mathematical relationship:

$$d ( {x}_{l} , {t}_{i} ) = c ( {x}_{l} , {t}_{i} ) * {e}^{j ∅ ( {x}_{l} , {t}_{i} )}$$

where d(xₗ, tᵢ) represents a phase-doubled seismic trace for the sample x recorded at channel l for time tᵢ. As previously discussed, the complex trace determined by block 130 is represented by the variable c(xₗ, tᵢ). The phase-increasing component is represented by the Euler formulation of doubling the instantaneous phase Ø(xₗ, tᵢ), where Ø(xₗ, tᵢ) depends from the complex trace c(xₗ, tᵢ). While the previous example discloses doubling the instantaneous phase, the data analysis system 108 may apply any suitable operation(s) to ensure the phase difference of any two signals of the gather does not cause destructive interference upon combination. For example, any even operator may be applied (e.g., a factor of 2, 4, 6, 8, etc.) to the instantaneous phase of the complex traces.

At block 134, the data analysis system 108 may stack the phase doubled traces into one waveform. As previously mentioned, “stacking” refers to the combination of seismic signal traces such that all seismic signal traces of an event are represented by one waveform. Accordingly, the data analysis system 108 may combine the traces by performing a summation of all elements within the seismic trace gather. The summation may be represented by the following relationship:

$$g ( {t}_{i} ) = {\sum }_{l = 1}^{l = m} d ( {x}_{l} , {t}_{i} + Δ {t}_{l} )$$

Where d(xₗ, tᵢ+Δtₗ) is the phase-doubled trace shifted with time amount Δtₗ for alignment, and g(tᵢ) is the summation result for the gather having a value m corresponding to the number of traces. The time-shift amount Δtₗ for each trace may be estimated via travel time picks, expected phase arrival times from modeling studies, and visual inspection of the data for coherent arrival times. In cases where the trace gather input to block 134 is already aligned for the seismic events, Δtₗ may be set to 0. As a result of combining the complex phase-increased traces, g(tᵢ) may be a single waveform represented by a complex trace, having a real and imaginary portion.

Moving to block 136, the data analysis system 108 may reduce the instantaneous phase of the stacked single waveform and maintain the real portion, such that the resulting waveform is a waveform to be expected if all traces of the seismic event originally displayed positive polarity. Further, the data analysis system 108 may determine a suitable reduction method based on the processing operation applied at block 132. For example, if the traces of the array were doubled at block 132, the data analysis system 108 may reduce the instantaneous phase of the single waveform by one half. Moreover, in preparation for the next data operation, the real portion of the complex trace may be retained during this block, and the resulting waveform may display the characteristics of the original seismic trace array. The aforementioned processing may be represented by the following relationship:

$${g}_{h} ( {t}_{i} ) = real ( g ( {t}_{i} ) * {e}^{\frac{- j {θ}_{i}}{2}} )$$

where gₕ(tᵢ) is the real phase-reduced stacked seismic trace, after the phase reduction component, consisting of the Euler formulation of the reduction of the instantaneous phase θᵢ of g(tᵢ) by one half, has been applied to the stacked waveform g(tᵢ). While the previous example discloses reducing the instantaneous phase of the stacked waveform by half, the data analysis system may apply any suitable operation(s) in response to the operation applied at block 132.

At block 138, the data analysis system 108 may determine the energy trace associated with the stacked waveform. To do so, the traces collected at block 126 may be squared, combined via summation along the coherent event, and multiplied by the number of seismic traces within the array. This may be illustrated by the following relationship:

$$e ( {t}_{i} ) = m {\sum }_{k = - n}^{k = n} {\sum }_{l = 1}^{l = m} {w ( {x}_{l} , {t}_{i + k} + Δ {t}_{l} )}^{2}$$

where the above relationship represents the summation of the original traces w(xₗ, tᵢ) for the event window time array, having a half-length of n, for m traces of the gather and shifted by the aforementioned time amount Δtₗ. The resulting value may represent the energy at time tᵢ associated with the seismic event of the seismic trace array.

Moving to block 140, the data analysis system 108 may determine the seismic semblance of the event by normalizing the phase-reduced stacked waveform determined at block 136 with the energy determined at block 138. This may be represented by the following relationship:

$${s}_{d} ( {t}_{i} ) = \frac{{\sum }_{k = - n}^{k = n} {{g}_{h} ( {t}_{i + k} )}^{2}}{e ( {t}_{i} )} = \frac{{\sum }_{k = - n}^{k = n} {{g}_{h} ( {t}_{i + k} )}^{2}}{m {\sum }_{k = - n}^{k = n} {\sum }_{l = 1}^{l = m} {w ( {x}_{l} , {t}_{i + k} + Δ {t}_{l} )}^{2}}$$

where s_{d}(tᵢ) is the seismic semblance, the denominator is the energy trace calculated at block 138, and the numerator is the summation of the squared phase-reduced seismic traces gₕ(tᵢ) during the event window time array having a half-length of n. Upon executing block 140, the seismic semblance may reflect the event coherency of the seismic trace array as polarity flips observed originally may be corrected by the processing described in prior blocks.

In response to the seismic semblance, or the coherent energy, determined at block 140, the data analysis system 108 may implement a number of controls at the geologic area of interest at block 142. By way of example, a control operation implemented by the data analysis system 108 may include controlling the flow rate of proppant into the hydraulic fracture after determining by the seismic semblance that the rock has fractured sufficiently. In another example, a control operation implemented by the data analysis system 108 may include controlling the firing rate of an air gun of a water-based seismic survey after determining by the seismic semblance that a particular underwater formation may contain hydrocarbon deposits. Further, source mechanism analysis by semblance determination may be integrated into the data analysis system 108 to perform control functions. For example, a control operation implemented by the data analysis system 108 may be automatically choosing a proper fracturing fluid in response to analyzing the seismic semblance of a source deployed in a land-based survey. While three examples are discussed above, it should be noted that a number of control operations may be performed at block 142 in response to event detection and source mechanism analysis by the seismic semblance determination.

While the above method 124 describes performing this process for a single seismic event, it should be noted that multiple seismic events may occur within a single gather. As a result, the data analysis system 108 may perform the above processing for each event of gather, simultaneously or in accordance with each discrete event. Further, the data analysis system 108 may allow an operator of the system to select which events of the gather processing may be applied to.

Moreover, while performing the method 124, the data analysis system 108 may display the results of operations performed at any block of the above method to an operator of the system via the display 122. For example, an operator may choose to view the original seismic traces received at block 126, and may be presented with a graphical representation of the results via the display 122. In another example, the operator may choose to view a graphical representation of the semblance determination performed at block 140 via the display 122. Additionally, in light of previous discussion, for a gather having multiple seismic events the display 122 may present a graphical representation of all seismic events of the seismic gather, or a specific seismic event chosen by the operator via the I/O ports 118 of the data analysis system 108.

With the above method in mind, the data analysis system 108 may be integrated into applications relating to seismic event detection and source mechanism analysis. For example, as previously mentioned, the data analysis system 108 may be deployed within the hydraulic fracturing operation of FIG. 2. Upon receiving seismic traces corresponding to a microseismic event, generated by successful hydraulic fracturing, the data analysis system 108 may perform the method 124 via the processor 112 and output a visual indicator indicating event detection based on the resulting semblance value. As such, information may be obtained from the visual indication such as the source location, source classification, and event timing.

Further, the resulting semblance value determined by block 140 may be used to determine the coherency of the signals of seismic events generated by active sources. For example, the data analysis system 108 may be deployed within a water survey of FIG. 1. Upon receiving seismic traces corresponding to an active source, such as an air gun, the data analysis system may be configured to perform the method 124 via the processor 112 and display a visual indicator that an event has occurred based on the resulting semblance value. The visual indicator may be any visual indication capable by the display 122, such as a graphical representation of the semblance determination performed at block 140 as previously mentioned. As such, information may be obtained from the visual indication such as the source location, source classification, and event timing.

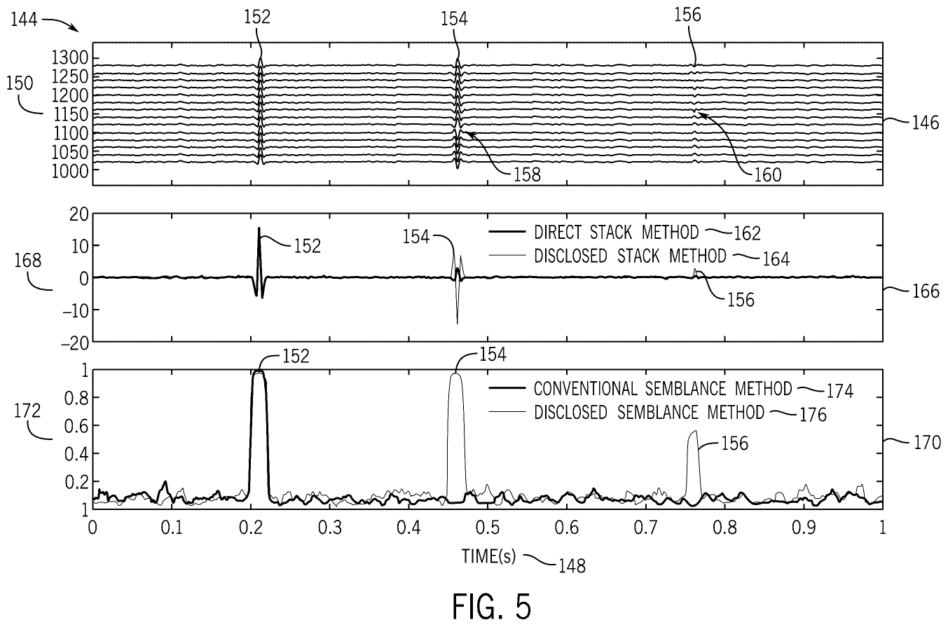

A number of examples of how the method 124 may be visually represented are discussed above. In addition to the foregoing discussion, the method 124 may also be shown to be advantageous over the conventional semblance determination. By way of introduction, FIG. 5. illustrates a visual representation of a workflow of the method 124 capable by the data analysis system 108 and the conventional seismic semblance determination, where the collection of graphs shares a time domain as represented by the time axis 148. Accordingly, each graph of the collection of graphs 144 represents a portion of the method executed by the data analysis system 108, in contrast to the conventional seismic semblance method.

As previously mentioned, the data analysis system 108 may receive a gather of seismic traces associated with seismic events. The graph 146 provides an illustrated example of the seismic traces plotted on a displacement axis 150 against the time axis 148. The seismic traces display seismic events 152, 154, and 156. Seismic events 152 and 154 displays traces that may be indicative of an event generated by an active source. However, all traces of seismic event 152 display consistent polarity. In contrast, seismic event 154 displays inconsistent polarity, having a polarity flip 158 near the center of the gather. Similarly, seismic event 156, which displays traces that may be indicative of a microseismic event generated by a passive source, displays a polarity flip 160 near the center of the gather.

The graph 166 provides an illustrated example of the result of stacking the traces of graph 146 manipulated by the processing described by method 124, referred to herein as the disclosed stack method 164, and the result of stacking the traces of graph 146 with no further manipulation, referred to herein as the direct stack method 162. In the illustrated example, the direct stack method 162 was able to yield the targeted stacked waveform for the seismic event 152 as it originally displayed positive polarity. Contrary to the previous, the direct stack method 162 of the seismic events 154 and 156 display destructive interference caused by inconsistent polarity upon combining the traces, indicated by the small resulting stack. This is further illustrated in the case of the direct stack method 162 result of microseismic event 156. However, upon compensating for the polarity flip (e.g. the operations applied to the instantaneous phase of each seismic trace) the stacked traces may display the expected waveform of the event, had the event displayed consistent polarity originally. As illustrated, the disclosed stack method 164 produces a result for seismic events 154 and 156 comparable to the directly stacked waveform displaying consistent polarity of seismic event 152.

Moving to graph 170, the semblance values determined by the conventional semblance method 174 and the disclosed semblance method 176, are shown plotted on the semblance axis 172 against the time axis 148. In this manner, the differences between using the conventional semblance method 174 and disclosed semblance method 176 are illustrated, particularly in the semblances determined for seismic event 154 and 156. When viewing the conventional semblance method 174 result, the seismic events 154 and 156 may not display the coherency of the event as compared to the disclosed semblance method 176 result. As such, the disclosed semblance method 176 result in the case of seismic events 152, 154, and 156, may be suitable for applications related to event detection, source mechanism analysis, and seismic processing steps (e.g, NMO stacking and migration) as compared to the conventional semblance method 174.

Technical effects for the embodiments described herein using the data analysis system 108 within operations where seismic semblance determinations may indicate the occurrence of seismic events and identify seismic sources. That is, rather than simply performing the method 124, the data analysis system 108 presents an integrable system to perform event detection and source mechanism analysis where the occurrence of seismic events may be an asset in driving operative decisions and/or controlling aspects of hydrocarbon-related operations. Further, the data analysis system 108 presents a solution to correct polarity reversals in data sets containing seismic traces. As such, the present embodiments described herein provide a positive impact in the field of seismic monitoring. Moreover, it should be noted that the method 124 is able to determine the coherent energy independent of model data or simulations provided by other third parties. Instead, the method 124 is a purely data driven approach that avoids reliance on models or other datasets outside of the received datasets described herein.

Reference throughout this specification to “one embodiment,” “an embodiment,” “embodiments,” “some embodiments,” “certain embodiments,” or similar language means that a particular feature, structure, or characteristic described in connection with the embodiment may be included in at least one embodiment of the present disclosure. Thus, these phrases or similar language throughout this specification may, but do not necessarily, all refer to the same embodiment. Although the present disclosure has been described with respect to specific details, it is not intended that such details should be regarded as limitations on the scope of the present disclosure, except to the extent that they are included in the accompanying claims.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform] ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A method, comprising:
receiving, via a processing system, a plurality of seismic traces from a plurality of seismic recorders associated with a geologic area of interest;
modifying, via the processing system, the plurality of seismic traces to obtain a consistent polarity for each seismic trace of the plurality of seismic traces;
generating, via the processing system, a single waveform based on the plurality of modified seismic traces; and
determining, via the processing system, a coherent energy value associated with the plurality of seismic traces based on the plurality of seismic traces and the single waveform.

2. The method of claim 1, wherein generating the single waveform comprises:
converting, via the processing system, the plurality of seismic traces into a plurality of complex traces;
increasing, via the processing system, an instantaneous phase of each complex trace of the plurality of complex traces to generate a plurality of updated complex traces; and
stacking, via the processing system, each updated complex trace of the plurality of updated complex traces to generate the single waveform.

3. The method of claim 2, further comprising:
restoring, via the processing system, the single waveform based on a factor applied when increasing the instantaneous phase of each complex trace of the plurality of complex traces; and
normalizing, via the processing system, the single waveform with an energy trace, wherein the energy trace is representative of a plurality of energy values associated with each of the plurality of seismic traces over a period of time.

4. The method of claim 3, wherein the plurality of seismic traces is converted into the plurality of complex traces using a signal processing algorithm.

5. The method of claim 4, wherein the signal processing algorithm comprises a Hilbert Transform.

6. The method of claim 2, wherein the instantaneous phase of each complex trace of the plurality of complex traces is increased to obtain a consistent polarity for each complex trace of the plurality of complex traces.

7. The method of claim 2, wherein increasing the instantaneous phase of each complex trace of the plurality of complex traces comprises doubling the instantaneous phase of each complex trace of the plurality of complex traces.

8. The method of claim 7, wherein restoring the single waveform comprises reducing an instantaneous phase of the single waveform by one-half.

9. A non-transitory computer-readable medium comprising computer-executable instructions that, when executed, cause a processing system to perform operations comprising:
receiving a plurality of seismic traces from a plurality of seismic recorders associated with a geologic area of interest, wherein each of the plurality of seismic traces is associated with an identical event arrival time;
modifying the plurality of seismic traces to obtain a consistent polarity for each seismic trace of the plurality of seismic traces;
generating a single waveform based on the plurality of modified seismic traces; and
determining a coherent energy value associated with the plurality of seismic traces based on the plurality of seismic traces and the single waveform.

10. The non-transitory computer-readable medium of claim 9, wherein the computer-executable instructions that, when executed, cause the processing system to generate the single waveform by:
converting the plurality of seismic traces into a plurality of complex traces;
increasing an instantaneous phase of each complex trace of the plurality of complex traces to generate a plurality of updated complex traces; and
stacking each updated complex trace of the plurality of updated complex traces to generate the single waveform.

11. The non-transitory computer-readable medium of claim 10, wherein the computer-executable instructions that, when executed, further cause the processing system to perform the operations comprising:
restoring the single waveform based on a factor applied when increasing the instantaneous phase of each complex trace of the plurality of complex traces; and
normalizing the single waveform with an energy trace, wherein the energy trace is representative of a plurality of energy values associated with each of the plurality of seismic traces over a period of time.

12. The non-transitory computer-readable medium of claim 11, wherein the computer-executable instructions that, when executed, further cause the processing system to perform the operations comprising adjusting an operation of a device based on the normalized single waveform.

13. The non-transitory computer-readable medium of claim 11, wherein the computer-executable instructions that, when executed, further cause the processing system to perform the operations comprising presenting the normalized single waveform via a display device.

14. The non-transitory computer-readable medium of claim 10, wherein the instantaneous phase of each complex trace of the plurality of complex traces is increased to obtain a consistent polarity for each complex trace of the plurality of complex traces.

15. A system, comprising:
a plurality of seismic recorders configured to acquire a plurality of seismic traces; and
a processing system configured to perform operations comprising:
receiving a plurality of seismic traces from a plurality of seismic recorders associated with a geologic area of interest;
processing the plurality of seismic traces for coherence analysis;
converting the processed plurality of seismic traces into a plurality of complex traces;
increasing an instantaneous phase of each complex trace of the plurality of complex traces to generate a plurality of updated complex traces;
stacking each updated complex trace of the plurality of updated complex traces along a coherent event to generate a single waveform;
determining an energy trace, wherein the energy trace is representative of a plurality of energy values associated with each of the plurality of seismic traces over a period of time;
restoring the single waveform based on a factor applied when increasing the instantaneous phase of each complex trace of the plurality of complex traces; and
normalizing the single waveform with the energy trace.

16. The system of claim 15, wherein the instantaneous phase of each complex trace of the plurality of complex traces is increased to obtain a consistent polarity for each complex trace of the plurality of complex traces.

17. The system of claim 15, wherein increasing the instantaneous phase of each complex trace of the plurality of complex traces comprises doubling the instantaneous phase of each complex trace of the plurality of complex traces.

18. The system of claim 17, wherein restoring the single waveform comprises reducing an instantaneous phase of the single waveform by one-half.

19. The system of claim 15, wherein the operations comprise adjusting an operation of a device based on the normalized single waveform.

20. The system of claim 15, wherein the operations comprise presenting the normalized single waveform via a display device.
